(19) United States
(12) Patent Application Publication
(10) Pub. No.: US 2009/0101004 A1
(43) Pub. Date: Apr. 23, 2009

(54) Two part piston for an internal combustion engine

(76) Inventor: Jerald L. Johnson, Las Vegas, NV (US)

Correspondence Address: JERALD L. JOHNSON, 8916 PENNYSTONE AVE., LAS VEGAS, NV, 89134, US

(21) Appl. No.: 12/288,154

(22) Filed: Oct. 17, 2008

Related U.S. Application Data
(60) Provisional application No. 60/981,474, filed on Oct. 19, 2007.

(51) Int. Cl. F02F 3/00; F16C 7/02

(52) U.S. Cl. 92/255; 123/193.6; 123/197.4

(57) ABSTRACT

A two-part piston for an internal combustion engine comprising an annular outer piston connected to the crankshaft by two connecting rods and an inner piston fit into the bore of the annular outer piston connected to the crankshaft by one connecting rod. The reciprocating motion of the inner and annular outer piston is controlled by the location of the respective connecting rod bearing journals on the crankshaft.

### FIELD OF INVENTION

The present invention relates to reciprocating internal combustion engines and more particularly to a two-part piston for an internal combustion engine.

### BACKGROUND OF THE INVENTION

In a reciprocating internal combustion engine various configurations of pistons, crankshafts and connecting rods are known and utilized.

A need exists for a two-part piston to improve the efficiency in today's high speed engines. Prior art depicts multiple part piston designs that too bulky for modern engines. Existing engines could not be retrofitted with these bulky multiple part pistons.

A lightweight two-part piston that provides for a longer duration time at the optimal crankshaft angle to increase the produced torque of the engine and increase the thermal efficiency of the engine for new engines and that can be utilized as a retrofit in an existing engine by changing out the pistons, connecting rods and crankshaft, is presented to meet this need.

### SUMMARY OF THE INVENTION

In accordance with an embodiment of the present invention, a two-part piston is disclosed. The device consists of an annular outer piston and an inner piston. The inner piston moves in a bore in the annular outer piston.

The annular outer piston; has a bore generally along the same axis as the engine cylinder for the inner piston to operate in, piston rings to seal it to the engine cylinder, one piston rod pin, and two connecting rods to the crankshaft, one rod being on each side of the bore through the piston. The inner piston fits into the bore of the annular outer piston, can move within the bore independent of the annular outer piston, is sealed to the bore of the annular outer piston with piston rings, has one piston rod pin, and one connecting rod to the crankshaft located between the two annular outer piston connecting rods. The reciprocating motion of the inner and annular outer piston is controlled by the location of the respective connecting rod bearing journals on the crankshaft.

The centerline of the bore through the annular outer piston can be offset from the centerline of the engine cylinder. The centerline of the bore through the annular outer piston can be at an angle to the centerline of the engine cylinder.

The inner piston connecting rod is longer than the two annular outer piston connecting rods and fits between them. The inner piston connecting rod has a slot for the annular outer piston rod to pass through and provides clearance for the annular outer piston rod pin as the engine reciprocates.

This configuration of a two-part piston allows the connecting rods to be very close together and the connecting rods to be straight from the piston connecting rod pins to the crankshaft, which reduces the weight. The inner piston connecting rod can be supported laterally by the two annular outer piston rods, which would further reduce the weight. The surfaces between the inner piston connecting rod and annular outer piston rods can be bearing surfaces lubricated by engine oil from the crankshaft, which would allow the inner piston connecting rod to be very light.

The advantages of this design are the very light weight that can be achieved for the moving parts, improved engine thermal efficiency, and existing engines could be retrofitted to this design by changing out the pistons, connecting rods, and crankshaft.

### BRIEF DESCRIPTION OF THE DRAWINGS

FIG. 1 is a cutaway view of the two-part piston with connecting rods and crankshaft assembled in the cylinder of an internal combustion engine.

FIG. 2A is a view of the connecting rod for the inner piston.

FIG. 2B is a view of the connecting rod for the annular outer piston.

FIG. 3A is a view of the two-part piston at the top of the firing stroke.

FIG. 3B is a view of the two-part piston at approximately 90 degrees of crankshaft angle after the top of the firing stroke.

FIG. 3C is a view of the two-part piston at approximately 180 degrees of crankshaft angle after the top of the firing stroke.

FIG. 3D is a view of the two-part piston at approximately 270 degrees of crankshaft angle after the top of the firing stroke.

### DETAILED DESCRIPTION OF THE PREFERRED EMBODIMENTS

In the following, various embodiments of the present invention will be described in detail with reference to the accompanying drawings.

For simplification of description, throughout the description, substantially same parts and constructions are denoted by the same numerals and repeated explanation of them will be omitted.

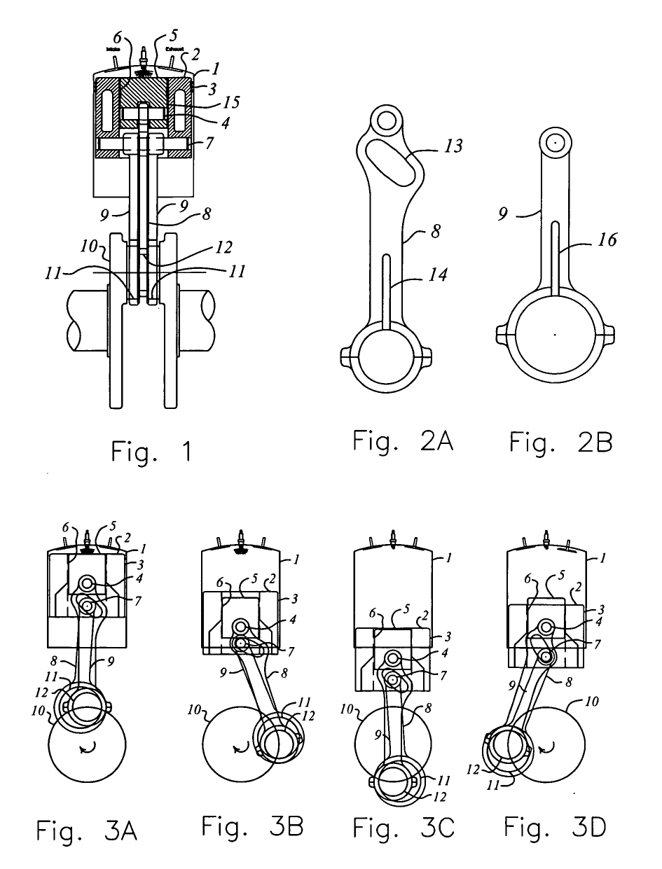

Referring to FIG. 1, a two part piston comprises an annular outer piston 2 fit into the cylinder 1 of an internal combustion engine; piston rings 3 seal the annular outer piston 2 to the cylinder 1; one connecting rod pin 7 and two connecting rods 9 connect the annular outer piston 2 to the annular outer piston rod journals 11 on the crankshaft 10; an inner piston 5 fit into the bore 15 of the annular outer piston 2; piston rings 6 to seal the inner piston 5 to the bore of the annular outer piston 2; one connecting rod pin 4 and one connecting rod 8 to connect the inner piston 5 to the inner piston rod journal 12 on the crankshaft 10.

Referring to FIG. 2A, an embodiment of the connecting rod 8 for the inner piston 5 is shown. The connecting rod 8 includes a slot 13 to provide clearance for the annular outer piston 2 connecting rod pin 7 and a groove 14 to allow engine oil from the crankshaft to lubricate the surfaces between the annular outer piston 2 connecting rods 9 and the inner piston 5 connecting rod 8.

Referring to FIG. 2B, an embodiment of the connecting rod 9 for the annular outer piston 2 is shown. The connecting rod 9 includes a groove 16 to allow engine oil to lubricate the surfaces between the annular outer piston 2 connecting rods 9 and the inner piston 5 connecting rod 8.

Referring to FIGS. 3A-3H, it can be seen that an annular outer piston 2, connected to the crankshaft 10 by connecting rod pin 7 and connecting rods 9, reciprocates in the engine cylinder 1 as the crankshaft 10 rotates. The inner piston 5, connected to the crankshaft 10 by connecting rod pin 4 and connecting rod 8, also reciprocates in the engine cylinder 1 as the crankshaft 10 rotates. The inner piston 5, also, moves within the bore 14 of the annular outer piston 2 as determined by the relative position of the crankshaft 10 journal 12 for the inner piston 5 connecting rod 8, to the crankshaft 10 journals 11 for the annular outer piston 2 connecting rods 9.

Although the invention has been described above with reference to the embodiments of the invention, the invention is not limited to such embodiments as described above. Various modifications and variations of such embodiments may be carried out by those skilled in the art, in light of the above description.

What is claimed is:

1. A two-part piston for an internal combustion engine comprising:
an annular outer piston comprising:
a combustion surface,
a cylindrical circumferential outer surface having at least one groove within the surface thereof,
at least one ring being positioned within the groove to form a substantially sealed sliding engagement between the outer surface of the annular outer piston and the inner surface of the engine cylinder,
a bore through the annular outer piston along the same axis as the engine cylinder into which an inner piston can be fitted,
a connecting rod pin, and
two connecting rods connected to the connecting rod pin on one end and connected to two journals on the crankshaft;
an inner piston mounted within the bore of the annular outer piston, comprising:
a combustion surface,
a cylindrical circumferential outer surface having at least one groove within the surface thereof,
at least one ring being positioned within the groove to form a substantially sealed sliding engagement between the outer surface of the piston and the inner surface of the bore through the annular outer piston,
a connecting rod pin, and
a connecting rod placed between the two connecting rods for the annular outer piston, connected to the inner piston connecting rod pin on one end and connected to a journal on the crankshaft located between the two annular outer piston connecting rod journals, with a slot in the inner piston connecting rod for the annular outer piston rod pin to pass through so as not to interfere with the connecting rod pin of the annular outer piston as the inner piston moves in the bore of the annular outer piston and as the annular outer piston and inner piston reciprocate in engine cylinder by rotation of the crankshaft.

2. The two-part piston for an internal combustion engine of claim 1 wherein the journal of the inner piston having been placed on the crankshaft with respect to the position of the journals of the annular outer piston to move the inner piston in within the bore through the annular outer piston to achieve a torque advantage on the crankshaft during the combustion stroke of the engine.

3. The two-part piston for an internal combustion engine of claim 1 wherein the journal of the inner piston having been placed on the crankshaft with respect to the position of the journals of the annular outer piston to move the inner piston in within the bore through the annular outer piston to achieve an efficiency advantage during the combustion stroke of the engine.

4. The two-part piston for an internal combustion engine of claim 1 wherein the bore through the annular outer piston is on an axis parallel to, but not the same as, the axis of the engine cylinder.

5. The two-part piston for an internal combustion engine of claim 1 wherein the bore through the annular outer piston is on an axis at an angle to the axis of the engine cylinder.

6. The two-part piston for an internal combustion engine of claim 1 wherein the adjoining surfaces of the connecting rods for the annular outer piston and the connecting rod for the inner piston are designed to provide a friction bearing surface to provide lateral stability to the inner piston connecting rod whereby allowing the connecting rod for the inner piston to be thinner and lighter in weight.

7. The two-part piston for an internal combustion engine of claim 1 wherein the adjoining surfaces of the connecting rods for the annular outer piston and the connecting rod for the inner piston are grooved with one or more grooves to provide a means for oil from the crankshaft to provide lubrication between the adjoining surfaces of the connecting rods for the annular outer piston and the connecting rod for the inner piston.
